(19) United States
(12) Patent Application Publication
(10) Pub. No.: US 2025/0095000 A1
(43) Pub. Date: Mar. 20, 2025

(54) TOKENIZATION FOR TRUSTFUL REPORTING OF BUILDING ENERGY PERFORMANCE

(71) Applicant: Konnecta Systems IKE, Attiki (GR)

(72) Inventors: Charilaos Niavis, Athens (GR); Stéphane Jean-Jacques Kündig, Carouge (CH); Andreas El Saer, Athens (GR); Marina Theoni Laskari, Attiki (GR)

(73) Assignee: Konnecta Systems IKE, Attiki (GR)

(21) Appl. No.: 18/401,525

(22) Filed: Dec. 31, 2023

(30) Foreign Application Priority Data
Sep. 15, 2023 (GR) 20230100742

(51) Int. Cl. G06Q 30/018; G06Q 50/16; G16Y 10/80; G16Y 40/20

(52) U.S. Cl. CPC G06Q 30/018; G06Q 50/16; G16Y 10/80; G16Y 40/20

(57) ABSTRACT

Trustful building performance reporting includes capturing sensor data from different buildings in a geographically defined space and locating, for each one of the different buildings, a corresponding smart contract stored in memory of a host computing platform. The method additionally includes processing individual ones of the sensor data for each one of the different buildings in a key performance indicator (KPI) computational rule stored in the corresponding smart contract in order to produce KPI values for each of the different buildings. Finally, the method includes tokenizing the one or more of the KPI values and transmitting each one of the one or more KPI values to a remotely disposed distributed ledger for storage therein in association with a corresponding one of the different buildings.

### CROSS-REFERENCE TO RELATED APPLICATIONS

This application claims priority under 35 U.S.C. § 119(a) to Greek patent application number 20230100742, filed on Sep. 15, 2023, the entire teachings of which are incorporated herein by reference.

### BACKGROUND OF THE INVENTION

### Field of the Invention

The present invention relates to the technical field of green building management and more particular to the computation of key performance indicators (KPIs) for different monitored buildings based upon Internet of things (IoT) sensor generated data.

### Description of the Related Art

From the exterior, a building appears as just a shell of a structure. But the building is so much more. The building is a complex set of interoperable systems including heating and cooling, power distribution, water distribution both potable and non-potable, elevators, powered doors and manual operated doors, and the like. The energy required to power these different systems can be substantial with changes in the selection, arrangement and deployment of each of these interoperable systems imparting a large impact on the overall energy consumption of the building.

Heretofore, the energy efficiency of a building could be measured only subjectively on an individual basis by one seeking to appreciate the energy consumption of the building, or metrically at only the highest level—the amount of energy consumed by the building over a period of time whether that energy is in the form of electric energy, gas consumption or oil consumption. Recent advancements in electronically networkable sensors, however, have provided new ways not only of more accurately and objectively quantifying energy consumption and energy efficiency of a building, but such advancements support the objective quantification of the impact of changes to aspects of the infrastructure of the building to the overall energy efficiency of the building.

As to these recent advancements, the determination of the overall energy efficiency of a building is one determined by a set of one or more KPIs established for the building by the] or by a public authority. Those KPIs can include quantifiable metrics such as total electricity consumed per unit time, total gas consumed per unit time, total electricity consumed per unit of space, total gas consumed per unit of space, total luminosity per unit of space, average interior temperature, energy consumed in arriving at room temperature, number of hours of peak energy consumption, and the like. Of course, every different building may compute its own KPI values for its own KPIs irrespective of the manner and method of other building computing the same or different KPI values.

It has been recognized that the most effective approach to reducing the carbon footprint of a cluster of buildings within a geographic area is a collective approach. The collective approach, however, requires an object selection of KPIs for all buildings in the cluster and the confidence that the KPI values produced for the KPIs are objectively determined so as to be reliable in reporting to regulatory agencies seeking to promote an optimized carbon footprint for the cluster and to support such optimization through incentivization. Incentivization, though, requires trust in KPI selection and KPI value reporting for the KPI selection.

### BRIEF SUMMARY OF THE INVENTION

Embodiments of the present invention address technical deficiencies of the art in respect to building performance monitoring and the trustful reporting of KPIs for buildings in a monitored cluster. To that end, embodiments of the present invention provide for a novel and non-obvious method for trustful building performance reporting. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for trustful building performance reporting includes capturing sensor data from different buildings in a geographically defined space and locating, for each one of the different buildings, a corresponding smart contract stored in memory of a host computing platform. The method additionally includes processing individual ones of the sensor data for each one of the different buildings in a KPI computational rule stored in the corresponding smart contract in order to produce KPI values for each of the different buildings. Finally, the method includes tokenizing the one or more of the KPI values and transmitting each one of the one or more KPI values to a remotely disposed distributed ledger for storage therein in association with a corresponding one of the different buildings.

In one aspect of the embodiment, each corresponding smart contract is stored in a privately accessible distributed ledger and the remotely disposed distributed ledger of the tokenized KPI values is a publicly accessible distributed ledger. In another aspect of the embodiment, the sensor data is captured from respectively different Internet of things (IoT) devices and the sensor data is normalized according to type information sensed by corresponding ones of the IoT devices into a uniform representation for the type of information. To that end, each of the IoT devices can be authenticated prior to processing the sensor data with ones of the sensor data from ones of the IoT devices failing to authenticate being discarded. Optionally, a threshold disparity can be detected as between specific ones of the sensor data of a specific one of the IoT devices. In response, the specific one of the IoT devices can be directed to re-sense and transmit new values in replacement of the specific ones of the sensor data.

In another embodiment of the invention, a data processing system is adapted for trustful building performance reporting. The system includes a host computing platform of one or more computers, each with memory and one or more processing units including one or more processing cores. The system also includes a trustful building performance reporting module. The module includes computer program instructions enabled while executing in the memory of at least one of the processing units of the host computing platform to capture sensor data from different buildings in a geographically defined space, locate for each one of the different buildings, a corresponding smart contract stored in memory of a host computing platform and process ones of the sensor data for each one of the different buildings in a KPI computational rule stored in the corresponding smart contract in order to produce KPI values for each of the different buildings. The instructions then tokenize the one or more of the KPI values and transmit each one of the one or more KPI values to a remotely disposed distributed ledger for storage therein in association with a corresponding one of the different buildings.

In this way, the technical deficiencies of the distributed and untrustworthy evaluation of carbon footprint for buildings in a cluster are overcome owing to collective reporting of IoT sensor data for evaluation within the smart contracts established for the buildings according to uniform KPI evaluation rules.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of trustful building performance reporting;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for trustful building performance reporting. In accordance with an embodiment of the invention, IoT sensed data may be collected from different sensors in different clusters of smart buildings, so that the data sensed by the IoT devices are processed in a central processing location. In this regard, the data is processed centrally to produce KPI values for each of the buildings based upon computational rules stored within the smart contracts of each of the buildings. The KPI values may then be selectively tokenized for publication into the blockchain, for instance should the KPI values satisfy a threshold value. In this way, the determination of the KPI values may be managed in a negotiated way outside of the individual buildings and centrally within the pre-stored and immutable smart contracts for the buildings so that KPI values of notable value are then tokenized for trustful building performance reporting.

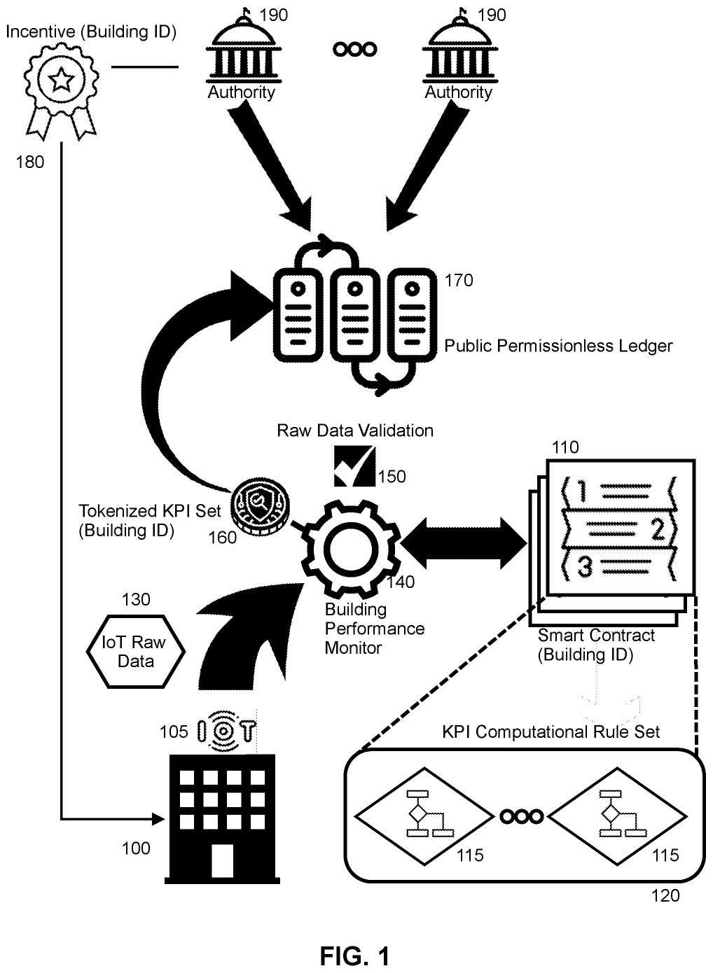

In illustration of one aspect of the embodiment, FIG. 1 pictorially shows a process of trustful building performance reporting. As shown in FIG. 1, different buildings 100 in a cluster of buildings (only a single building shown for the purpose of illustrative simplicity) include respectively different sets of IoT devices 105, each sensing a particular condition within a corresponding one of the buildings 100, for instance temperature, humidity, electricity consumption, gas consumption, illuminance and the like. The values 130 captured by the sensing of each of the IoT devices 105 are transmitted over a computer communications network to a building performance monitor 140, for instance by way of a secure communications link. Upon receipt, the values 130 can be submitted to a validation process 150. The validation process can include, for example ensuring that the values 130 fall within an expected range, the minimization of data outliers, anomalies or unrealistic values in general by validating the values 130 against past values from the IoT devices 105 to confirm the likely validity of the values 130 and to ensure the authenticity of those values 130. As well, the validation process 150 can include ensuring that each of the values 130 has associated therewith a valid timestamp

Thereafter, the building performance monitor 140 for each corresponding one of the buildings 100, retrieves from persistent storage an associated smart contract 110 including therein a set 120 of different KPI computational rules 115 for different KPIs. Then, for each of the values 130 of a respective one of the IoT devices 105 of the corresponding one of the buildings 100, the building performance monitor 140 submits the values 130 to a corresponding one of the KPI computational rules 115 within the set 120 of the different KPI computational rules 115 of the associated one of the smart contracts 110 of the corresponding one of the buildings 100 so as to produce respective resulting KPI values.

Finally, the building performance monitor 140 tokenizes the KPI values produced by application of the KPI computational rules 115 of the set 120 into a token 160 in reference to the corresponding one of the buildings 100. The building performance monitor 140 then stores each generated token 160 in a publicly accessible permissionless ledger 170 exposing a private application programming interface (API) for authorized end users 190. In this regard, an authorized end user 190 can include a building performance authority or governmental regulatory body. In reliance on the content of a particular token 160 in the ledger 170, the authorized end users 190 can transmit a resulting credit document 180 to a selected one of the buildings 100 referenced by the particular token 160. In this regard, the credit document 180 can be a non-monetary certification of compliance or certification of performance of the selected one of the buildings 100, or a monetary credit against fees or taxes owed.

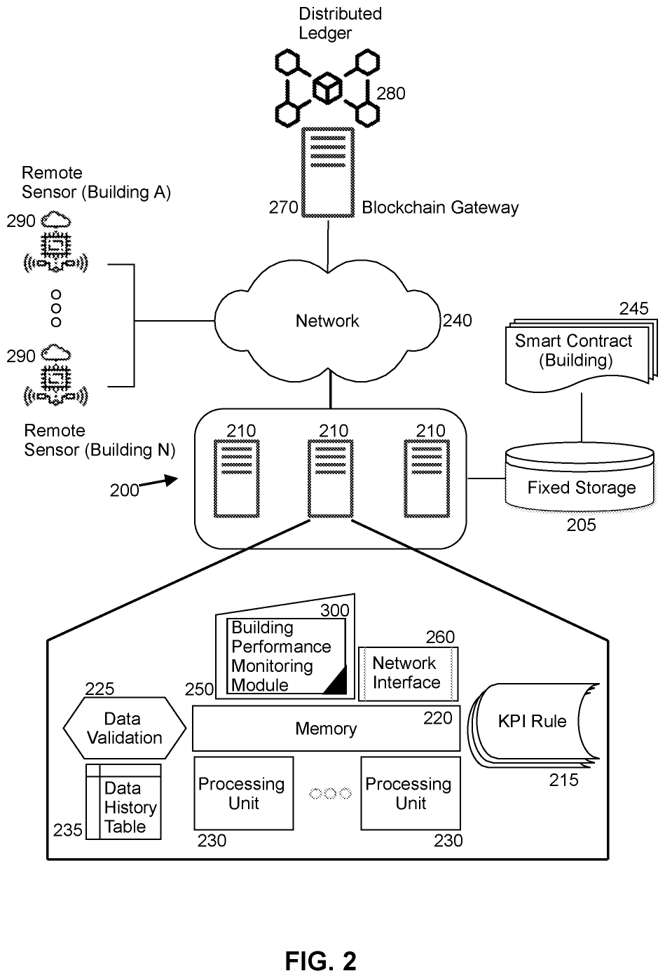

Aspects of the process described in connection with FIG. 1 can be implemented within a data processing system. In further illustration, FIG. 2 schematically shows a data processing system adapted to perform trustful building performance reporting. In the data processing system illustrated in FIG. 2, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

Different IoT sensors 290 of corresponding buildings are communicatively coupled to the host computing platform 200 by way of the data communications network 240. Each of the different IoT sensors 290 transmits sensed values over the data communications network 240 to the host computing platform. As well, the host computing platform 200 is communicatively coupled to a remotely disposed blockchain gateway 270 supporting an API accessing a distributed ledger 280. Finally, the host computing platform 200 includes persistent storage 205 storing therein different smart contracts 245 for respectively different buildings. It is to be recognized, however, that the smart contracts 245 can be stored also in the distributed ledger 280 accessible through the blockchain gateway 270.

Notably, a computing device 250 including a non-transitory computer readable storage medium can be included within the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for trustful building performance reporting. Specifically, the program instructions during execution establish a secure point to point data communications link with different ones of the IoT sensors 290 and thereafter receive over the data communications link different raw data values from the different ones of the IoT sensors 290 in connection with respectively different buildings. The program instructions upon receipt of a raw data value from a particular one of the IoT sensors 290 of a corresponding building submits the raw data value to a data validation process 225. The data validation process 225 ensures that each of raw data value has a valid timestamp and falls within an expected range of value, such as by comparing the raw data value to past values for the particular one of the IoT sensors 290 in the corresponding building stored in a data history table 235.

To the extent that the comparison produces a variance within a pre-determined threshold, the program instructions of the module 300 retrieve one of the smart contracts 245 for the corresponding building and loads into the memory 220 different KPI rules 215 for the retrieved one of the smart contracts 245. Then, the program instructions submit the raw data value to an associated one of the KPI rules 215 in order to produce a KPI value. Thereafter, the program instructions tokenize the KPI value into a token and the program instructions access the API of the blockchain gateway 270 in order to upload the token to the distributed ledger 280 in connection with the corresponding building.

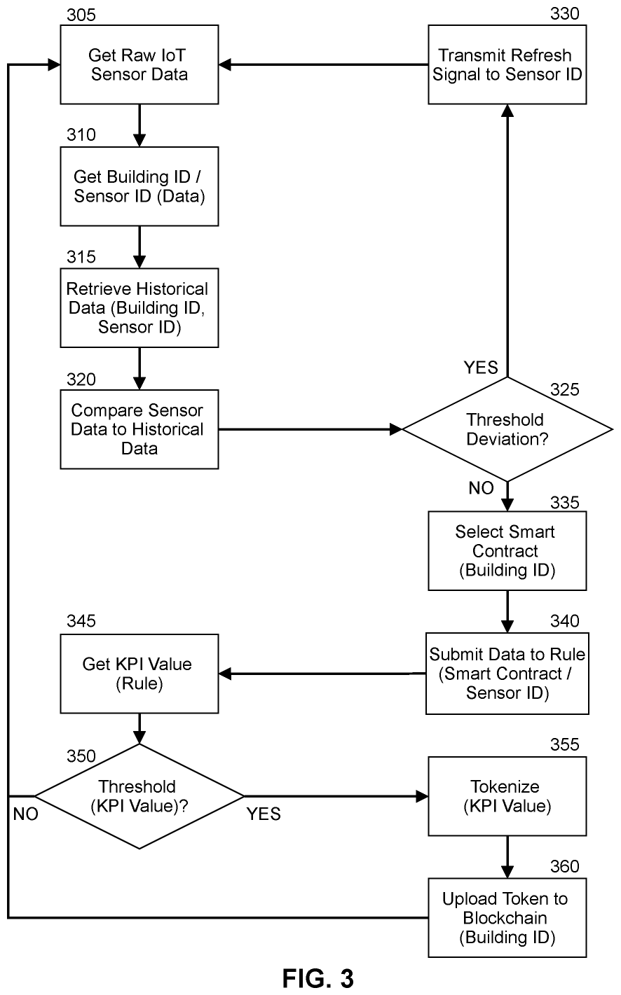

In further illustration of an exemplary operation of the module, FIG. 3 is a flow chart illustrating one of the aspects of the process of FIG. 1. Beginning in block 305, raw IoT data is received from an IoT sensor of a particular sensor type disposed within a particular building for which a smart contract has been established. In block 310, the identity of the building is determined as is the sensor identity. In block 315, past raw values from the IoT sensor of the particular building are retrieved and in block 320, the raw IoT data is compared to the historical data of the past raw values in order to determine in decision block 325 if a threshold disparity exists between the raw IoT data and the past raw values. If so, a refresh signal is transmitted to the IoT sensor in block 330 requesting a re-sensing and re-submission of IoT data. But, otherwise, the process continues through block 335.

In block 335, a smart contract is retrieved from persistent storage in connection with the building identity. Then, in block 340, the raw IoT data is provided as an input parameter to a corresponding KPI computational rule disposed within the smart contract and associated with the identity of the IoT sensor. In response, in block 345, a KPI value is received as output from the KPI computational rule. In decision block 350, it is determined whether or not the KPI value crosses a pre-determined threshold indicative of tokenization. If so, in block 355 a token is created for the KPI value through a conventional cryptographic tokenization process in order to produce an immutable encapsulator of the KPI value. Finally, in block 360 the token is uploaded to the blockchain in connection with the identity of the building.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for trustful building performance reporting comprising:
capturing sensor data from different buildings in a geographically defined space;
locating for each one of the different buildings, a corresponding smart contract stored in memory of a host computing platform;
processing ones of the sensor data for each one of the different buildings in a key performance indicator (KPI) computational rule stored in the corresponding smart contract in order to produce KPI values for each of the different buildings; and,
tokenizing the one or more of the KPI values and transmitting each one of the one or more KPI values to a remotely disposed distributed ledger for storage therein in association with a corresponding one of the different buildings.

2. The method of claim 1, wherein the sensor data is captured from respectively different Internet of things (IoT) devices and the sensor data is normalized according to type information sensed by corresponding ones of the IoT devices into a uniform representation for the type of information.

3. The method of claim 2, wherein each of the IoT devices is authenticated prior to processing the sensor data with ones of the sensor data from ones of the IoT devices failing to authenticate being discarded.

4. The method of claim 1, wherein each said corresponding smart contract is stored in a privately accessible distributed ledger and the remotely disposed distributed ledger of the tokenized KPI values in a publicly accessible distributed ledger.

5. The method of claim 2, further comprising:
detecting a threshold disparity between specific ones of the sensor data of a specific one of the IoT devices and responding to the threshold disparity by directing the specific one of the IoT devices to re-sense and transmit new values in replacement of the specific ones of the sensor data.

6. A data processing system adapted for trustful building performance reporting, the system comprising:
a host computing platform comprising one or more computers, each with memory and one or processing units including one or more processing cores; and,
a trustful building performance reporting module comprising computer program instructions enabled while executing in the memory of at least one of the processing units of the host computing platform to perform:
capturing sensor data from different buildings in a geographically defined space;
locating for each one of the different buildings, a corresponding smart contract stored in memory of a host computing platform;
processing ones of the sensor data for each one of the different buildings in a key performance indicator (KPI) computational rule stored in the corresponding smart contract in order to produce KPI values for each of the different buildings; and,
tokenizing the one or more of the KPI values and transmitting each one of the one or more KPI values to a remotely disposed distributed ledger for storage therein in association with a corresponding one of the different buildings.

7. The system of claim 6, wherein the sensor data is captured from respectively different Internet of things (IoT) devices and the sensor data is normalized according to type information sensed by corresponding ones of the IoT devices into a uniform representation for the type of information.

8. The system of claim 7, wherein each of the IoT devices is authenticated prior to processing the sensor data with ones of the sensor data from ones of the IoT devices failing to authenticate being discarded.

9. The system of claim 6, wherein each said corresponding smart contract is stored in a privately accessible distributed ledger and the remotely disposed distributed ledger of the tokenized KPI values in a publicly accessible distributed ledger.

10. The system of claim 7, wherein the instructions are further enabled to perform:
detecting a threshold disparity between specific ones of the sensor data of a specific one of the IoT devices and responding to the threshold disparity by directing the specific one of the IoT devices to re-sense and transmit new values in replacement of the specific ones of the sensor data.

11. A computing device comprising a non-transitory computer readable storage medium having program instructions stored therein, the instructions being executable by at least one processing core of a processing unit to cause the processing unit to perform a trustful building performance reporting by:
capturing sensor data from different buildings in a geographically defined space;
locating for each one of the different buildings, a corresponding smart contract stored in memory of a host computing platform;
processing ones of the sensor data for each one of the different buildings in a key performance indicator (KPI) computational rule stored in the corresponding smart contract in order to produce KPI values for each of the different buildings; and,
tokenizing the one or more of the KPI values and transmitting each one of the one or more KPI values to a remotely disposed distributed ledger for storage therein in association with a corresponding one of the different buildings.

12. The device of claim 11, wherein the sensor data is captured from respectively different Internet of things (IoT) devices and the sensor data is normalized according to type information sensed by corresponding ones of the IoT devices into a uniform representation for the type of information.

13. The device of claim 12, wherein each of the IoT devices is authenticated prior to processing the sensor data with ones of the sensor data from ones of the IoT devices failing to authenticate being discarded.

14. The device of claim 11, wherein each said corresponding smart contract is stored in a privately accessible distributed ledger and the remotely disposed distributed ledger of the tokenized KPI values in a publicly accessible distributed ledger.

15. The device of claim 12, wherein the processing unit further performs:
detecting a threshold disparity between specific ones of the sensor data of a specific one of the IoT devices and responding to the threshold disparity by directing the specific one of the IoT devices to re-sense and transmit new values in replacement of the specific ones of the sensor data.
